(19) United States
(12) Patent Application Publication
(10) Pub. No.: US 2009/0152877 A1
(43) Pub. Date: Jun. 18, 2009

(54) APPARATUS FOR LOCKING GLOVEBOX

(75) Inventor: Byoung Wook Kim, Ansan-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/324,405

(22) Filed: Nov. 26, 2008

(30) Foreign Application Priority Data
Dec. 12, 2007 (KR) 10-2007-0129285

(51) Int. Cl. B65D 55/14; E05C 1/12

(52) U.S. Cl. 292/174; 70/158

(57) ABSTRACT

An apparatus for locking a glovebox may include a push button, a first slider, a second slider, and a locking member. The push button is elastically supported on a dashboard. The first slider is rotatably mounted inside the push button, and has a first inclined face at the rear end thereof. The second slider has a second inclined face corresponding to the first inclined face of the first slider, and moves in a transverse direction to unlock the glovebox when the second inclined face is pressed by the first inclined face. The locking member rotates the first slider such that the second inclined face is not pressed by the first inclined face.

### CROSS-REFERENCE TO RELATED APPLICATIONS

The present application claims priority to Korean Application No. 10-2007-0129285, filed on Dec. 12, 2007, the entire contents of which are incorporated herein for all purposes by this reference.

### BACKGROUND OF THE INVENTION

1. Field of the Invention

The present invention relates to an apparatus for locking a glovebox built into the dashboard of a vehicle.

2. Description of Related Art

Such a glovebox is built into the dashboard, located over the front-seat passenger's footwell in a vehicle. The glovebox is configured so that a cover thereof is locked or unlocked by pressing a push button.

The cover of the glovebox can be easily locked and unlocked using the push button. However, because anyone can open the glovebox by pressing the push button, it is difficult to store valuables in the glovebox. For this reason, the owner of the vehicle feels dissatisfied with the storage space of the vehicle and is uncomfortable using it. This leads to a reduction in the merchantability of the vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF INVENTION

Various aspects of the present invention are directed to provide an apparatus for locking a glovebox for a vehicle, which make it possible to store goods in the glovebox through a simple locking configuration and to lock the glovebox.

According to an aspect of the present invention, an apparatus for locking a glovebox may include a push button elastically supported on a dashboard by an elastic member and being selectively movable toward the dashboard, a locking member rotatably coupled to the push button and integrally movable toward the dashboard with the push button, a first slider co-axially coupled to the locking member and being integrally rotatable with the locking member, the first slider including a first inclined face at a rear end thereof, and/or a second slider including a second inclined face selectively facing the first inclined face of the first slider according to rotation of the locking member, wherein the second slider is movable toward a striker of the glovebox in a predetermined angle with rotation axis of the first slider to unlock the glovebox when the second inclined face is pressed by the first inclined face rotated by the locking member.

The predetermined angle may be approximately 90 degrees.

Lateral side of the second slider may be slidably supported by a guide member in a longitudinal direction of the second slider, wherein the guide member is disposed with the predetermined degree with the rotation axis of the first slider so that movement direction of the second slider is changed by the guide member.

A cutout recess may be formed at the rear end of the first slider and abuts on the first inclined face and lower portion of the first inclined face is connected to the cutout recess.

The cutout recess may be cut out from the rear end of the first slider to a size that prevents the first inclined face of the first slider to contact with the second inclined face of the second slider when the locking member is pressed toward the dashboard such that the second inclined face is not pressed by the first inclined face when the second inclined face faces the cutout recess of the first slider.

The first inclined face and the cutout recess of the first slider may be disposed at different angles of inclination with respect to a cross section of the first slider.

The first inclined face may be approximately one quarter of a cross section of the first slider.

The cutout recess may be approximately half a cross section of the first slider.

The locking member may include a key hole in a front thereof, a key inserted into the key hole and rotating the locking member and the first slider integrally

The dashboard includes a guide hole through which the striker of the glovebox is locked or unlocked.

The guide hole, the striker, and the first slider may be co-axially aligned.

The striker may be biased by an elastic member toward the dashboard.

One end portion of the striker may be shaped of wedge.

Another aspect of the present invention is directed to an apparatus for locking a glovebox, including a push button elastically supported on a dashboard, a first slider rotatably mounted within the push button, and having a first inclined face provided on a rear end thereof, a second slider having a second inclined face corresponding to the first inclined face of the first slider, and moving in a transverse direction to unlock the glovebox when the second inclined face is biased transversely by the first inclined face, and/or a locking member, which rotates the first slider into and out of engagement with the second inclined face.

The locking member may include a key hole in a front of the first slider, a key for insertion into the key hole and for rotating the first slider, and a cutout recess formed at the rear end of the first slider immediately adjacent to the first inclined face.

The dashboard may include a guide hole through which a striker of the glovebox is locked and unlocked.

The cutout recess may be cut out from the rear end of the first slider and dimensioned and configured to prevent contact with the second inclined face of the second slider when the push button is pressed.

The first inclined face and the cutout recess of the first slider may be disposed at different angles of inclination with respect to a cross section of the first slider.

The first inclined face may be about one-quarter of a cross section of the first slider, and the cutout recess may be about one-half a cross section of the first slider

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 illustrates a glovebox according to an exemplary embodiment of the present invention.

FIG. 2A is a sectional view taken along the line A-A of FIG. 1, in which an apparatus for locking a glovebox according to an exemplary embodiment of the present invention is locked.

FIG. 2B is a sectional view taken along the line A-A of FIG. 1, in which an apparatus for locking a glovebox according to an exemplary embodiment of the present invention is unlocked.

FIG. 3A is a detailed perspective view illustrating a first slider installed on an apparatus for locking a glovebox according to an exemplary embodiment of the present invention, viewed from the position of the inclined face of the first slider.

FIG. 3B is a side view of the first slider of FIG. 3A when viewed from the same direction as in 3B.

FIG. 3C is a detailed perspective view illustrating a first slider installed on an apparatus for locking a glovebox according to an exemplary embodiment of the present invention, viewed from the position of the cutout recess of the first slider.

FIG. 3D is a side view of the first slider of FIG. 3C when viewed from the same direction as in 3D.

FIG. 4A is a sectional view illustrating the locked state of an apparatus for locking a glovebox according to an exemplary embodiment of the present invention, in which the cutout recess of a first slider is oriented to the inclined face of a second slider.

FIG. 4B is a sectional view illustrating the locked state of an apparatus for locking a glovebox according to an exemplary embodiment of the present invention, in which the inclined face of a second slider is positioned in the cutout recess of a first slider.

### DETAILED DESCRIPTION OF INVENTION

Reference will now be made in detail to various embodiments of the present inventions), examples of which are illustrated in the accompanying drawings and described below. While the inventions) will be described in conjunction with exemplary embodiments, it will be understood that present description is not intended to limit the inventions) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

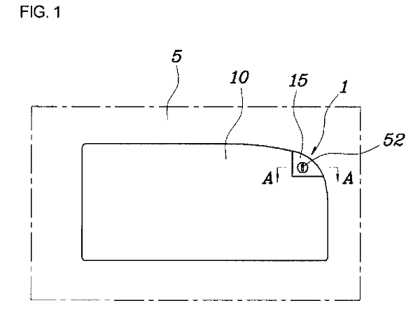

As illustrated in FIG. 1, a glovebox locking apparatus 1 can selectively lock and unlock the glovebox 10 built into the dashboard 5 of a vehicle.

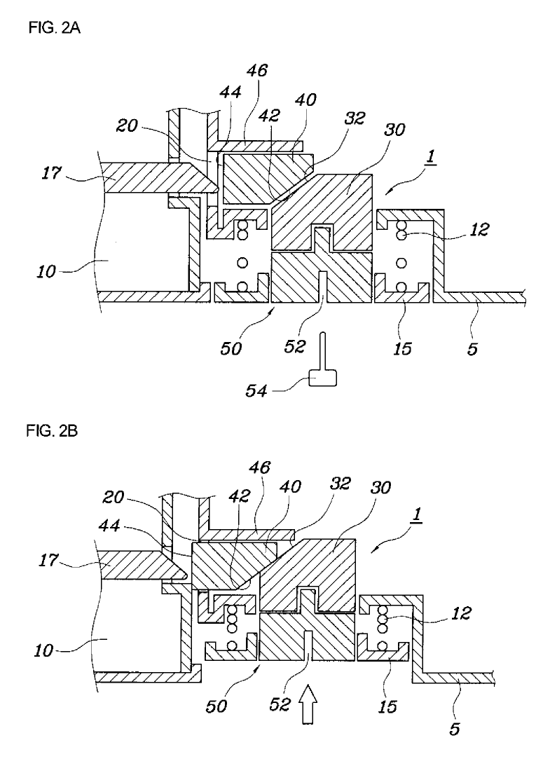

As illustrated in FIGS. 2A and 2B, the glovebox locking apparatus 1 includes a push button 15, which is elastically supported on the dashboard 5, which abuts on one side of the glovebox 10, through a spring 12. The push button 15 is configured to move backwards and forwards relative to the dashboard 5 due to the spring 12.

More specifically, as illustrated in FIG. 2B, when the push button 15 is pressed into the dashboard 5, one end portion of a striker 17 of the glovebox 10 comes out of a guide hole 20, and thus the glove box 10 is unlocked. As illustrated in FIG. 2A, when the push button 15 is released from the pressed state, the push button 15 returns to its original position by means of the elastic recovery force of the spring 12. At this time, the striker 17 of the glove box 10 is inserted into the guide hole 20, and thus the glovebox 10 is locked. More detailed explanation will be followed hereinafter.

The other end portion of the striker 17 is supported by an elastic member toward the push button in a normal state. Furthermore the one end of the striker 17 is wedged so that the glovebox 10 can easily move toward the dashboard 5 by a user but once locked by elastic force of the elastic member in the dashboard 5, it cannot move out unless external force is applied to the one end thereof.

The glovebox locking apparatus 1 includes a locking member 50 rotatably mounted to the push button 15, and a first slider 30 coupled to the locking member 50 inside the push button 15 so that the first slider 30 is rotated by the locking member 50.

The first slider 30 has a first inclined face 32 at the rear end thereof. The first slider 30 is coupled to the locking member 50 in the middle of the push button 15 and rotatable therein. The first slider 30 and the locking member 50 can move forward into the dashboard 5 together with the push button 15 when the push button 15 is pressed and the locking member 50 with the first slider 30 can rotate in the push button 15.

The glovebox locking apparatus 1 further includes a second slider 40, whose longitudinal direction is disposed in parallel to the front surface of the glovebox 10, wherein the second slider 40 is slidably supported by a guide member 46 disposed in parallel to longitudinal direction of the second slider 40.

The second slider 40 has a second inclined face 42, which is selectively in contact with the first inclined face 32 according to rotation of the first slider 30. The second slider 40 is configured to move in a transverse direction in contact with the striker 17 inserted into the guide hole 20 of the dashboard 5. To this end, the second slider 40 includes the second inclined face 42, corresponding to the first inclined face 32 of the first slider 30, on one side thereof, and a flat face 44 coming into contact with one end of the striker 17 on the other side thereof.

The second inclined face 42 of the second slider 40 comes into surface contact with the first inclined face 32 of the first slider 30. Thus, when the first slider 30 is pushed into the dashboard 5, the second inclined face 42 of the second slider 40 slides along the first inclined face 32 of the first slider 30.

The forward movement of the first slider 30 causes the transverse movement of the second slider 40 via the guide member 46. At this time, the second slider 40 pushes the striker 17 into the guide hole 20, and thus the glovebox 10 is unlocked. When the first slider 30 moves backwards to lock the glovebox 10 by the spring 12, the striker 17 is pushed in a transverse direction by the elastic member coupled to the other end portion of the striker 17, thereby the second slider 40 and the striker 17 returning to their original position.

The locking member 50 rotates the first slider 30 such that the first inclined face 32 of the first slider 30 deviates from the second inclined face 42 of the second slider 40. The locking member 50 further includes a slit-shaped key hole 52 in the front thereof in order to rotate the first slider 30, and a key 54 is inserted into the key hole 52 and rotates the first slider 30 coupled to the locking member 50.

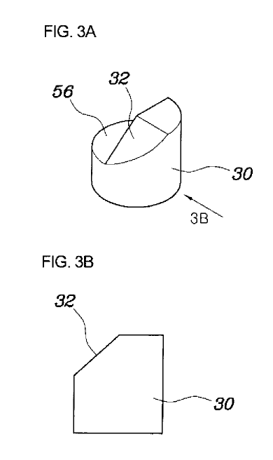

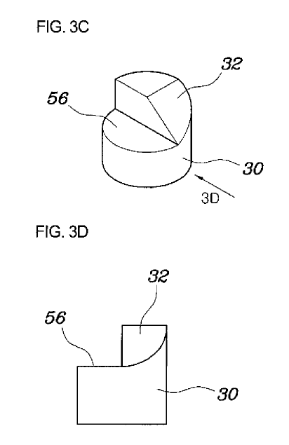

As illustrated in FIGS. 3A through 3D, the first slider 30 includes a cutout recess 56 abutting on the first inclined face 32. The cutout recess 56 has a recessed structure so as to abut on the first inclined face 32. The cutout recess 56 allows the first inclined face 32 of the first slider 30 to deviate from the second inclined face 42 of the second slider 40 when the first slider 30 is rotated by the rotation of the locking member 50.

The cutout recess 56 is designed so that, when the push button 15 is pressed, the first slider 30 approaches the second inclined face 42 of the second slider 40, but does not come into contact with the second inclined face 42 of the second slider 40 because of the cutout recess 56. Thus, even when the push button 15 is pressed, the first slider 30 fails to push the second slider 40 in a transverse direction.

The first inclined face 32 and cutout recess 56 of the first slider 30 are disposed so as to intersect each other at an angle of 90° till angle 180° in a circumferential direction in various embodiments of the present invention. More specifically, the first inclined face 32 and the cutout recess 56 of the first slider 30 abut each other. Further, on the basis of a cross section of the slider 30 having a cylinder, the first inclined face 32 is one quarter of the cross section, and the cutout recess 56 is half a cross section.

With this structure, when the locking member 50 rotates the first slider 30 at an angle of 90°, the second inclined face 42 of the second slider 40 can be selectively brought into contact with the first inclined face 32 or the cutout recess 56.

In this manner, the glovebox locking apparatus 1 can selectively maintain the glovebox 10, built into the dashboard 5 of the vehicle, in a locked state or in an unlocked state.

In the case in which the glovebox 10 is to be maintained in the unlocked state, as illustrated in FIGS. 2A and 2B, the first inclined face 32 of the first slider 30 is positioned so as to be in contact with the second inclined face 42 of the second slider 40, and then the push button 15 is pressed. Then, the first slider 30 moves forward into the dashboard 5 together with the push button 15, thereby pushing the second slider 40 in a transverse direction. Thus, the second slider 40 pushes the striker 17 to maintain the glovebox 10 in the unlocked state.

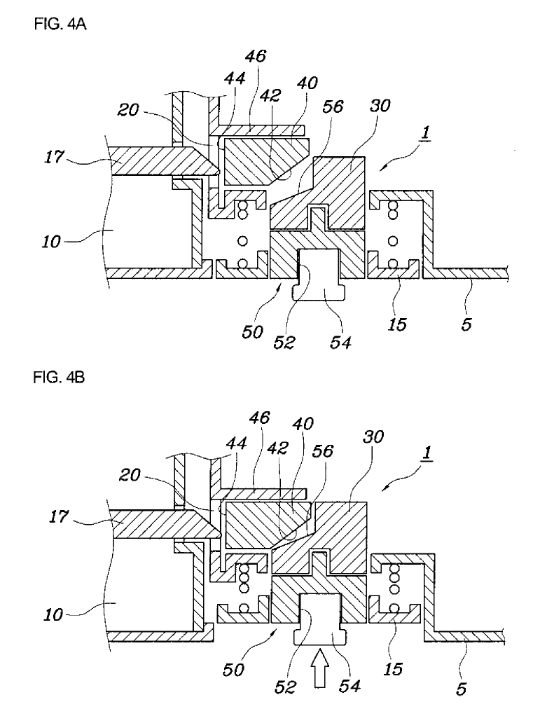

In contrast, in the case in which the glovebox 10 is to be maintained in the locked state, as illustrated in FIG. 4A, the key 54 is inserted into the key hole 52 in the locking member 50, and then the first slider 30 is rotated by the locking member 50 at an angle of 90° in a clockwise direction. Then, the cutout recess 56 of the first slider 30 is oriented toward the second inclined face 42 of the second slider 40. In this state, when the push button 15 is pressed as illustrated in FIG. 4B, the first slider 30 moves forward into the dashboard 5 together with the push button 15, thereby approaching the second inclined face 42 of the second slider 40. At this time, due to the cutout recess 56, the first slider 30 does not push the second inclined face 42 of the second slider 40. Thus, the glovebox 10 is maintained in the locked state.

Further, in the case in which the glovebox is to be changed from the locked state to the unlocked state again, the key 54 is inserted into the key hole 52 of the locking member 50, and then the first slider 30 is rotated at an angle of 90° in a counterclockwise direction. Then, the first inclined face 32 of the first slider 30 is oriented toward the second inclined face 42 of the second slider 40. At this time, when the push button 15 is pressed, the glovebox 10 is maintained in the unlocked state.

In this manner, the first slider 30 includes the first inclined face 32 and the cutout recess 56, which are disposed at different angles of inclination, at the rear end thereof. Thus, the user can rotate the first slider 30 through selective use of the key hole 52 and the key 54 of the locking member 50, so that the glovebox 10 can be maintained in the unlocked state or in the locked state.

For convenience in explanation and accurate definition in the appended claims, the terms “fronf” and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for locking a glovebox, comprising:
a push button elastically supported on a dashboard by an elastic member and being selectively movable toward the dashboard;
a locking member rotatably coupled to the push button and integrally movable toward the dashboard with the push button;
a first slider co-axially coupled to the locking member and being integrally rotatable with the locking member, the first slider including a first inclined face at a rear end thereof; and
a second slider including a second inclined face selectively facing the first inclined face of the first slider according to rotation of the locking member, wherein the second slider is movable toward a striker of the glovebox in a predetermined angle with rotation axis of the first slider to unlock the glovebox when the second inclined face is pressed by the first inclined face rotated by the locking member.

2. The apparatus according to claim 1, wherein the predetermined angle is approximately 90°.

3. The apparatus according to claim 1, wherein lateral side of the second slider is slidably supported by a guide member in a longitudinal direction of the second slider, wherein the guide member is disposed with the predetermined degree with the rotation axis of the first slider so that movement direction of the second slider is changed by the guide member.

4. The apparatus according to claim 1, wherein a cutout recess is formed at the rear end of the first slider and abuts on the first inclined face and lower portion of the first inclined face is connected to the cutout recess.

5. The apparatus according to claim 4, wherein the cutout recess is cut out from the rear end of the first slider to a size that prevents the first inclined face of the first slider to contact with the second inclined face of the second slider when the locking member is pressed toward the dashboard such that the second inclined face is not pressed by the first inclined face when the second inclined face faces the cutout recess of the first slider.

6. The apparatus according to claim 4, wherein the first inclined face and the cutout recess of the first slider are disposed at different angles of inclination with respect to a cross section of the first slider.

7. The apparatus according to claim 4, wherein the first inclined face is approximately one quarter of a cross section of the first slider.

8. The apparatus according to claim 4, wherein the cutout recess is approximately half a cross section of the first slider.

9. The apparatus according to claim 1, wherein the locking member includes a key hole in a front thereof, a key inserted into the key hole and rotating the locking member and the first slider integrally.

10. The apparatus according to claim 1, wherein the dashboard includes a guide hole through which the striker of the glovebox is locked or unlocked.

11. The apparatus according to claim 10, wherein the guide hole, the striker, and the first slider are co-axially aligned.

12. The apparatus according to claim 1, wherein the striker is biased by an elastic member toward the dashboard.

13. The apparatus according to claim 1, wherein one end portion of the striker is shaped of wedge.

14. A passenger vehicle comprising a glovebox and the apparatus for locking a glovebox according to claim 1.

15. An apparatus for locking a glovebox, comprising:
a push button elastically supported on a dashboard;
a first slider rotatably mounted within the push button, and having a first inclined face provided on a rear end thereof;
a second slider having a second inclined face corresponding to the first inclined face of the first slider, and moving in a transverse direction to unlock the glovebox when the second inclined face is biased transversely by the first inclined face; and
a locking member, which rotates the first slider into and out of engagement with the second inclined face.

16. The apparatus according to claim 15, wherein the locking member includes a key hole in a front of the first slider, a key for insertion into the key hole and for rotating the first slider, and a cutout recess formed at the rear end of the first slider immediately adjacent to the first inclined face.

17. The apparatus according to claim 15, wherein the dashboard includes a guide hole through which a striker of the glovebox is locked and unlocked.

18. The apparatus according to claim 16, wherein the cutout recess is cut out from the rear end of the first slider and dimensioned and configured to prevent contact with the second inclined face of the second slider when the push button is pressed.

19. The apparatus according to claim 16, wherein the first inclined face and the cutout recess of the first slider are disposed at different angles of inclination with respect to a cross section of the first slider.

20. The apparatus according to claim 16, wherein the first inclined face is about one-quarter of a cross section of the first slider, and the cutout recess is about one-half a cross section of the first slider.
